(19) United States
(12) Patent Application Publication
(10) Pub. No.: US 2009/0015625 A1
(43) Pub. Date: Jan. 15, 2009

(54) Printing Apparatus And Cleaning Mechanism Thereof

(75) Inventor: Ryuhei Sumida, Kyoto (JP)

Correspondence Address: MCDERMOTT WILL & EMERY LLP, 600 13TH STREET, N.W., WASHINGTON, DC, 20005-3096, US

(73) Assignee: Dainippon Screen Mfg, Co., Ltd., Kyoto (JP)

(21) Appl. No.: 11/664,395

(22) PCT Filed: Nov. 13, 2006
(86) PCT No.: PCT/JP2006/322544

§ 371 Date: Mar. 30, 2007

(30) Foreign Application Priority Data
Nov. 21, 2005 (JP) 2005-335271
Oct. 6, 2006 (JP) 2006-275175

(51) Int. Cl. B41J 2/165

(52) U.S. Cl. 347/30

(57) ABSTRACT

The present invention relates to a printing apparatus and a cleaning mechanism thereof.

A capping unit (302) includes a plurality of caps (301). Among the caps (301), a separate cleaning cap (301a) is connected by a tube (314) having a second valve (312) to a pump (310) for sucking ink from inkjet heads (101). Other caps are connected to the pump (310) by a tube (313) having a first valve (311). At the time of steady state, the first valve (311) and the second valve (312) are kept open to suck ink from all the inkjet heads (101). At the time of occurrence of defective ejection, only the second valve (312) is kept open to suck ink only from an inkjet head (101) having an ejection defect.

### TECHNICAL FIELD

The present invention relates to printing apparatuses, and particularly to a printing apparatus that performs printing by ejecting ink and a cleaning mechanism thereof.

### BACKGROUND ART

Conventionally, there are known inkjet type printing apparatuses (hereinafter, referred to as “inkjet printer”), which perform printing by ejecting ink onto paper by means of heat or pressure. The inkjet printer include printing apparatuses for business use, which are provided with an inkjet unit wider than the width of printing paper to, for example, perform printing on a large-sized sheet in one pass, and such an inkjet unit is provided with an inkjet head group consisting of a plurality of inkjet heads, each having an array of nozzles for ejecting ink. In such inkjet printer, for example, if ink in a nozzle is dried out, the nozzle might be clogged, causing defective ink ejection. When defective ink ejection occurs, a process for cleaning the inkjet heads is performed. In the cleaning process, for example, ink with increased viscosity, air bubbles, etc., are removed by sucking ink from nozzles with a pump. In addition, when the apparatuses are not in use, printing surfaces of the inkjet heads are capped (i.e., sealing the printing surfaces with caps) to prevent the nozzles from being dried out.

Conventionally, the number of inkjet heads in such inkjet printer is low, so each inkjet head is provided with a cleaning mechanism. In recent years, however, the inkjet printer have become larger in size and higher in performance, so that the number of inkjet heads provided therein is increased. Accordingly, providing each of the inkjet heads with a cleaning mechanism increases the apparatus size and cost. Therefore; in generally employed configurations, the cleaning mechanism is provided for each set of plural inkjet heads or each array.

Japanese Laid-Open Patent Publication No. 2000-225715 discloses an inkjet printer as shown in FIG. 18, which includes rubber caps 41 capable of suction from an array of nozzles on a color-by-color basis and a rubber cap 61 capable of suction from nozzles for all (four) colors. The printer is provided with a cleaning mechanism that uses the rubber caps 41 for ink suction and a cleaning mechanism that uses the rubber cap 61 for ink suction. These two cleaning mechanisms are switched to perform suction depending on the situation with a view to reducing ink consumption.

[Patent Document 1] Japanese Laid-Open Patent Publication No. 2000-225715

### DISCLOSURE OF THE INVENTION

### Problems to be Solved by the Invention

In the case of performing a process for collectively cleaning a plurality of inkjet heads at the time of occurrence of defective ink ejection, however, ink is sucked by a pump from inkjet heads having no defect in ejection ink. As a result, ink that is not required to be sucked is also sucked, resulting in waste of ink. In addition, filling the inkjet heads with ink is also performed by sucking ink from the nozzles, but there are variations in ink flow between inkjet heads having air bubbles left in their tubes, which are ink passages, and inkjet heads filled with ink. Accordingly, when filling a plurality of inkjet heads with ink, even if ink suction is similarly performed on the inkjet heads, ink does not readily flow through tubes having air bubbles left therein, and therefore the amount of ink sucked from the inkjet heads filled with ink becomes significant, resulting in unnecessary ink consumption. In addition, the printer disclosed in Patent Document 1 is required to include two different cleaning mechanisms, and therefore cannot be reduced in size and cost.

Therefore, an object of the present invention is to provide a printer capable of suppressing unnecessary ink consumption without increasing the size and cost of the apparatus.

### Means for Solving the Problems

A first aspect of the present invention is directed to a printing apparatus having a plurality of printheads, each performing printing by ejecting ink from a printing surface thereof to deposit the ink on printing paper, the apparatus comprises:

a cleaning mechanism for cleaning the plurality of printheads, the mechanism performing a first cleaning process for collectively cleaning a predetermined number of printheads from among the plurality of printheads and a second cleaning process for separately cleaning only one selected printhead, which is selected from among the predetermined number of printheads; and

a control portion for controlling an operation of the cleaning mechanism,

wherein the control portion switches between the first cleaning process and the second cleaning process in the cleaning mechanism.

In a second aspect of the present invention, based on the first aspect of the present invention, the cleaning mechanism includes a separate cleaning portion for separately cleaning the selected printhead in the second cleaning process, and the control portion causes the separate cleaning portion to clean a predetermined printhead from among the predetermined number of printheads in the first cleaning process.

In a third aspect of the present invention, based on the second aspect of the present invention, the cleaning mechanism includes a plurality of capping mechanisms for sealing each printing surface of the predetermined number of printheads and cleans the printheads by sucking the ink therefrom via the capping mechanisms, the control portion causes the cleaning mechanism to suck the ink from the predetermined number of printheads via the plurality of capping mechanisms in the first cleaning process and causes the cleaning mechanism to suck the ink from the selected printhead via the capping mechanism as the separate cleaning portion in the second cleaning process.

In a fourth aspect of the present invention, based on the third aspect of the present invention, the cleaning mechanism includes a first valve which, in an open state, allows the ink to be sucked via the capping mechanisms, excluding the capping mechanism as the separate cleaning portion of the plurality of capping mechanisms, and a second valve which, in an open state, allows the ink to be sucked via the capping mechanism as the separate cleaning portion, the control portion includes a valve controller for controlling an opening and closing operation of the first valve and an opening and closing operation of the second valve, the valve controller keeps the first valve and the second valve open in the first cleaning process and keeps the first valve closed, while keeping the second valve open, in the second cleaning process.

In a fifth aspect of the present invention, based on the first aspect of the present invention, the printing apparatus further comprises an inspection device for detecting a printhead having a defect in ejecting the ink from among the plurality of printheads.

In a sixth aspect of the present invention, based on the first aspect of the present invention, the cleaning mechanism further includes a wiper for wiping the printing surfaces of the predetermined number of printheads, and the control portion causes the wiper to wipe the printing surface of the selected printhead in the second cleaning process.

In a seventh aspect of the present invention, based on the first aspect of the present invention, the printing apparatus further comprises an operating condition monitoring section for monitoring operating conditions of the plurality of printheads, and when an inactive printhead is detected by the operating condition monitoring section, the control portion causes the cleaning mechanism to operate in such a manner that the second cleaning process is performed on the inactive printhead.

An eighth aspect of the present invention is directed to a printing apparatus having a plurality of printheads, each performing printing by ejecting ink from a printing surface thereof to deposit the ink on printing paper, the apparatus comprises:

a cleaning mechanism for cleaning the plurality of printheads, the mechanism performing a first cleaning process for collectively cleaning a predetermined number of printheads from among the plurality of printheads and a second cleaning process for separately cleaning only one selected printhead, which is selected from among the predetermined number of printheads;

a control portion for controlling an operation of the cleaning mechanism, the operation including switching between the first cleaning process and the second cleaning process; and

an operating condition sensing section for sensing operating conditions of the plurality of printheads based on externally provided image data,

wherein the operating condition sensing section detects, as a separate cleaning target printhead, a printhead that is inactive for a time period equal to or more than a predetermined percentage of a given time period, and

wherein when one or more separate cleaning target printheads are detected by the operating condition sensing section, the control portion causes the cleaning mechanism to operate in such a manner that the second cleaning process is performed on each of the one or more separate cleaning target printheads as the selected printhead.

In a ninth aspect of the present invention, based on the eighth aspect of the present invention, the operating condition sensing section divides the image data into a plurality of pieces of image data, each corresponding to a print width of a printhead, and obtains a print ratio of each printhead in a predetermined period based on the divided image data, and detects the separate cleaning target printhead based on the print ratio.

In a tenth aspect of the present invention, based on the ninth aspect of the present invention, the operating condition sensing section detects a printhead having a print ratio of 0% as the separate cleaning target printhead.

In an eleventh aspect of the present invention, based on the ninth aspect of the present invention, the operating condition sensing section detects a printhead having a print ratio equal to or less than a predetermined print ratio as the separate cleaning target printhead.

In a twelfth aspect of the present invention, based on the eighth aspect of the present invention, the cleaning mechanism includes a separate cleaning portion for separately cleaning the selected printhead in the second cleaning process, and the control portion causes the separate cleaning portion to clean a predetermined printhead from among the predetermined number of printheads in the first cleaning process.

In a thirteenth aspect of the present invention, based on the twelfth aspect of the present invention, the cleaning mechanism includes a plurality of capping mechanisms for sealing each printing surface of the predetermined number of printheads and cleans the printheads by sucking the ink therefrom via the capping mechanisms, the control portion causes the cleaning mechanism to suck the ink from the predetermined number of printheads via the plurality of capping mechanisms in the first cleaning process and causes the cleaning mechanism to suck the ink from the selected printhead via the capping mechanism as the separate cleaning portion in the second cleaning process.

In a fourteenth aspect of the present invention, based on the thirteenth aspect of the present invention, the cleaning mechanism includes a first valve which, in an open state, allows the ink to be sucked via the capping mechanisms, excluding the capping mechanism as the separate cleaning portion of the plurality of capping mechanisms, and a second valve which, in an open state, allows the ink to be sucked via the capping mechanism as the separate cleaning portion, the control portion includes a valve controller for controlling an opening and closing operation of the first valve and an opening and closing operation of the second valve, the valve controller keeps the first valve and the second valve open in the first cleaning process and keeps the first valve closed, while keeping the second valve open, in the second cleaning process.

In a fifteenth aspect of the present invention, based on the eighth aspect of the present invention, the printing apparatus further comprises an inspection device for detecting a printhead having a defect in ejecting the ink from among the plurality of printheads.

In a sixteenth aspect of the present invention, based on the eighth aspect of the present invention, the cleaning mechanism further includes a wiper for wiping the printing surfaces of the predetermined number of printheads, and the control portion causes the wiper to wipe the printing surface of the selected printhead in the second cleaning process.

A seventeenth aspect of the present invention is directed to a cleaning mechanism for a printing apparatus having a plurality of printheads, wherein a first cleaning process for collectively cleaning a predetermined number of printheads from among the plurality of printheads and a second cleaning process for separately cleaning only one selected printhead selected from among the predetermined number of printheads can be switched.

In an eighteenth aspect of the present invention, based on the seventeenth aspect of the present invention, the cleaning mechanism comprises a separate cleaning portion for separately cleaning the selected printhead in the second cleaning process, and the separate cleaning portion cleans a predetermined printhead from among the predetermined number of printheads in the first cleaning process.

### ADVANTAGES OF THE INVENTION

According to the first aspect, the printing apparatus is provided with the cleaning mechanism capable of switching between the first cleaning process for collectively cleaning a plurality of printheads and the second cleaning process for cleaning only one printhead. Accordingly, for example, the plurality of printheads can be collectively subjected to a cleaning process at the time of power-on, and if defective ink ejection has occurred in a printhead, the printhead can be separately subjected to a cleaning process. Thus, in the printing apparatus, printhead cleaning processes are effectively performed and unnecessary ink suction at the time of cleaning is reduced.

According to the second aspect, the separate cleaning portion is used both for collectively cleaning a plurality of printheads and for cleaning only one printhead. Accordingly, it is not necessary to include a mechanism for cleaning only one printhead, in addition to a mechanism for collectively cleaning a plurality of printheads. Thus, it is possible to achieve a printing apparatus capable of switching between cleaning processes at low cost without enlarging the apparatus size.

According to the third aspect, while a cleaning process is performed by sucking ink from printheads, the ink is sucked from only one printhead in the second cleaning process. Accordingly, for example, if defective ink ejection has occurred in a printhead, it is possible to suck ink only from the printhead that requires ink suction without sucking ink from printheads that require no ink suction because of not having an ejection defect. Thus, it is possible to suppress unnecessary ink suction, thereby consumption of ink is reduced.

According to the fourth aspect, the operation of sucking ink from printheads is controlled by controlling the opening and closing of two valves provided in one cleaning mechanism. Thus, it is possible to suppress unnecessary ink suction at low cost without enlarging the apparatus size, thereby consumption of ink is reduced.

According to the fifth aspect, a printhead having a defect in ejecting ink is detected by the inspection device. Thus, it is possible to identify a printhead having an ejection defect without requiring any manual effort, and perform a separate cleaning process on that printhead.

According to the sixth aspect, in the second cleaning process, for example, when defective ink ejection occurs, wiping a printing surface of a printhead targeted for a cleaning process by the wiper is performed. Thus, it is possible to more effectively perform printhead cleaning processes.

According to the seventh aspect, each printhead is separately subjected to a cleaning process based on the operating condition of the printhead. Printheads that are not being used for a printing process are susceptible to defective ink ejection in general, and therefore inactive printheads are each subjected in advance to a separate cleaning process, whereby the occurrence of the defective ink ejection can be prevented in advance.

According to the eighth aspect, the printing apparatus is provided with the cleaning mechanism capable of switching between the first cleaning process for collectively cleaning a plurality of printheads and the second cleaning process for cleaning only one printhead. Thus, if an ejection defect has occurred in a printhead, the printhead can be subjected to a separate cleaning process, so that unnecessary ink suction is reduced. In addition, the operating condition of each printhead is sensed based on externally provided image data, and a separate cleaning process is performed on any printhead (separate cleaning target printhead) that is inactive for a time period equal to or more than a predetermined percentage of a given time period. Accordingly, it is possible to perform a cleaning process on the separate cleaning target printhead in advance before printing the externally provided image data or perform a separate cleaning process before and after the printing. Thus, the occurrence of the defective ink ejection can be prevented.

According to the ninth aspect, the separate cleaning target printhead is identified based on a print ratio of each printhead in a predetermined time period, which is obtained based on image data divided into pieces, each corresponding to a print width of a printhead. In addition, only the separate cleaning target printhead is subjected to a cleaning process by the second cleaning process. Thus, as in the eighth aspect, unnecessary ink suction is reduced and the occurrence of the defective ink ejection can be prevented.

According to the tenth aspect, a separate cleaning process is performed on any printhead having a print ratio of 0%. Thus, it is possible to effectively perform a cleaning process on any printhead susceptible to an ejection defect.

According to the eleventh aspect, a separate cleaning process is performed on any printhead having a print ratio equal to or less than a predetermined print ratio. Thus, it is possible to effectively perform a cleaning process on any printhead relatively susceptible to a ejection defect based on a print ratio set by, for example, the user.

### BRIEF DESCRIPTION OF THE DRAWINGS

FIG. 1 is a schematic configuration diagram of a substantial portion of an inkjet printing apparatus according to a first embodiment of the present invention.

FIG. 2 is a plan view of an inkjet head group as viewed from the bottom in the embodiment.

FIG. 3 is a plan view of another exemplary inkjet head group as viewed from the bottom in the embodiment.

FIG. 4 is a cross-section view of a cleaning portion and a head unit in the embodiment.

FIG. 5 is a plan view of a cleaning unit as viewed from the top in the embodiment.

FIG. 6 is a cross-section view illustrating the head unit and the cleaning portion for explaining a cleaning operation at the time of steady state in the embodiment.

FIG. 7 is a cross-section view illustrating the head unit and the cleaning portion for explaining a cleaning operation at the time of occurrence of defective ejection in the embodiment.

FIG. 8 is a schematic configuration diagram of a substantial portion of an inkjet printing apparatus according to a first variant of the embodiment.

FIG. 9 is a diagram for explaining the operation of an inspection device in the first variant.

FIG. 10 is a cross-section view of a cleaning portion according to a second variant of the embodiment.

FIG. 11A is a representation in which a head unit has been moved in such a manner that a defective ejection head and a separate cleaning cap are opposed to each other in the second variant,

FIG. 11B is a representation in which the defective ejection head has its printing surface covered with the separate cleaning cap in the second variant,

FIG. 11C is a representation in which a wiper is in an elevated state in the second variant;

FIG. 11D is a representation in which the head unit has been moved in the second variant, and FIG. 11E is a representation in which the wiper is in a lowered state in the second variant.

FIG. 12 is a block diagram for explaining the operation of a printer section in a first example of a second embodiment of the present invention.

FIG. 13 is a flowchart for explaining the operation of the printer section in the first example.

FIG. 14 is a block diagram for explaining the operation of a printer section in a second example of the second embodiment of the present invention.

FIG. 15A is a representation of image data sent from an image apparatus in the second example, and FIG. 15B is a representation of the image data, which has been divided into a plurality of pieces, each corresponding to a print width of an inkjet head, in the second example.

FIG. 16 is a flowchart for explaining an operation of the printer section in the second example.

FIG. 17 is a flowchart illustrating another exemplary operation of the printer section in the second example.

FIG. 18 is a block diagram of a cleaning mechanism for an inkjet printing apparatus in an example of conventional art.

### LEGEND

2 printer section
10 printing portion
20 control portion
30 cleaning portion (cleaning mechanism)
40 inspection device
100 inkjet head group
101 inkjet head
101X defective ejection head
102, 103, 104, 105 head unit
110 inkjet head driver
200 inkjet head controller
210 capping unit controller
215 valve controller
220 head carriage controller
301 cap
301a separate cleaning cap
302, 303, 304, 305 capping unit
310 pump
311, 312 valve
313, 314 tube (suction tube)
320 wiper

### BEST MODE FOR CARRYING OUT THE INVENTION

Hereinafter, embodiments of the present invention will be described with reference to the accompanying drawings.

### 1. First Embodiment

<1.1 Overall Configuration>

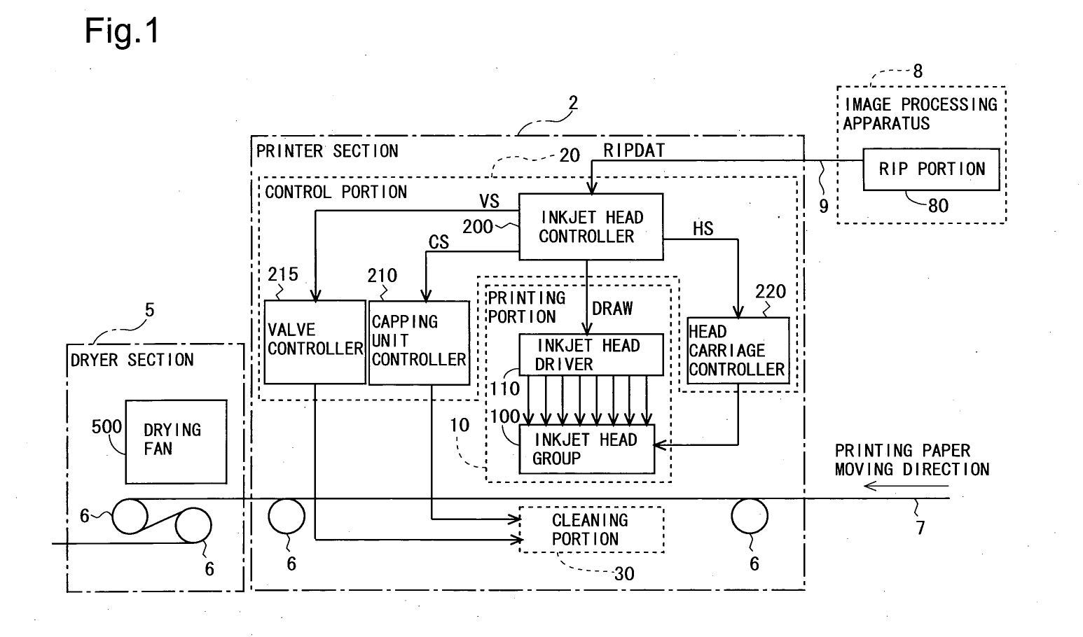

FIG. 1 is a schematic configuration diagram of a substantial portion of an inkjet printer according to a first embodiment of the present invention. The substantial portion of the printer is comprised of a printer section 2 and a dryer section 5. The printer section 2 includes a printing portion 10, a control portion 20, and a cleaning portion (cleaning mechanism) 30. The printing portion 10 includes an inkjet head group 100, and an inkjet head driver 110 for driving each inkjet head (printhead) included in the inkjet head group 100. The control portion 20 includes an inkjet head controller 200, for example, for controlling the operation of each inkjet head, a capping unit controller 210 for controlling the operation of the below-described capping unit included in the cleaning portion 30, a valve controller 215 for controlling the operation of the below-described valves included in the cleaning portion 30, and a head carriage controller 220 for controlling the movement of the below-described head units included in the inkjet head group 100. The dryer section 5 includes a drying fan 500. In addition, a belt 7 for feeding printing paper and rollers 6 for moving the belt 7 are provided in the printer section 2 and the dryer section 5. Note that the printer is connected to an external image processing apparatus 8 via a network 9, and image data RIPDAT targeted for printing is sent from a RIP portion 80 in the image processing apparatus 8 to the inkjet head controller 200.

The inkjet head controller 200 provides a drawing signal DRAW to the inkjet head driver 110 based on the image data RIPDAT sent from the RIP portion 80 in the image processing apparatus 8. In addition, the inkjet head controller 200 provides a capping unit movement instruction signal CS for controlling the elevating and lowering of the capping unit to the capping unit controller 210, and also provides a valve control signal VS for controlling the opening and closing of the valves to the valve controller 215. Further, the inkjet head controller 200 provides a head unit movement instruction signal HS for controlling the movement of the head units to the head carriage controller 220. The capping unit controller 210 causes the capping unit to be elevated or lowered, in accordance with the capping unit movement instruction signal CS provided from the inkjet head controller 200. The valve controller 215 opens or closes the valves in accordance with the valve control signal VS provided from the inkjet head controller 200. The head carriage controller 220 moves the head units in accordance with the head unit movement instruction signal HS provided from the inkjet head controller 200. The inkjet head driver 110 drives each inkjet head included in the inkjet head group 100 such that printing on printing paper is performed in a desired manner in accordance with the drawing signal DRAW provided from the inkjet head controller 200. The inkjet head group 100 performs printing onto printing paper. The cleaning portion 30 prevents defective ink ejection by, for example, performing a cleaning process on the inkjet heads and capping printing surfaces of the inkjet heads to prevent nozzles of the inkjet heads from being dried out. The drying fan 500 dries printed printing paper sent from the printer section 2 to the dryer section 5.

<1.2 Configuration of Inkjet Head Group>

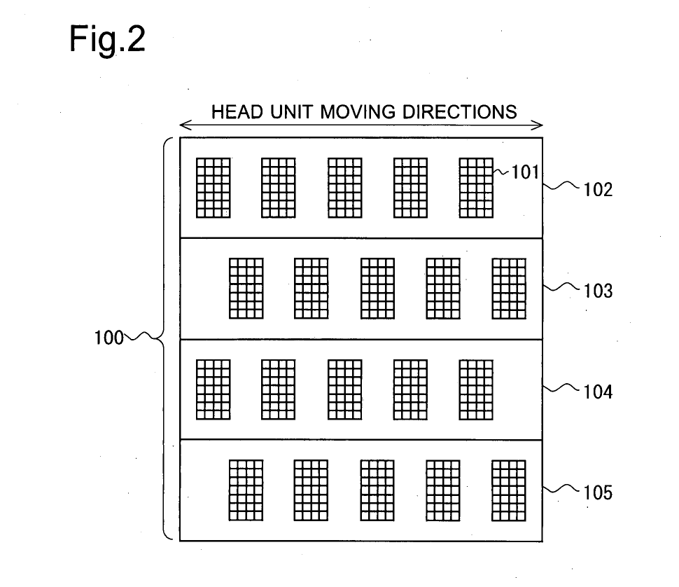

FIG. 2 is a plan view of the inkjet head group 100 as viewed from the bottom in the present embodiment. The inkjet head group 100 is comprised of four head units (also referred to as “trays”) 102 to 105 each having a plurality of inkjet heads 101, and is capable of printing on a large-sized sheet in one pass. Each inkjet head 101 is provided with a plurality of nozzles (not shown) for ejecting ink.

The head unit 102 includes inkjet heads 101 for ejecting C color (Cyan) ink. The head unit 103 includes inkjet heads 101 for ejecting M color (Magenta) ink. The head unit 104 includes inkjet heads 101 for ejecting Y color (yellow) ink. The head unit 105 includes inkjet heads 101 for ejecting K color (Black) ink. These head units 102 to 105 are capable of individually moving in directions indicated by the arrow in FIG. 2. Note that a single head unit normally ejects two color inks (e.g., the head units 102 and 103 eject C and M color inks, and the head units 104 and 105 eject Y and K color inks) to perform printing in one pass as described above, but for convenience of explanation, a single head unit is assumed to eject only one color ink.

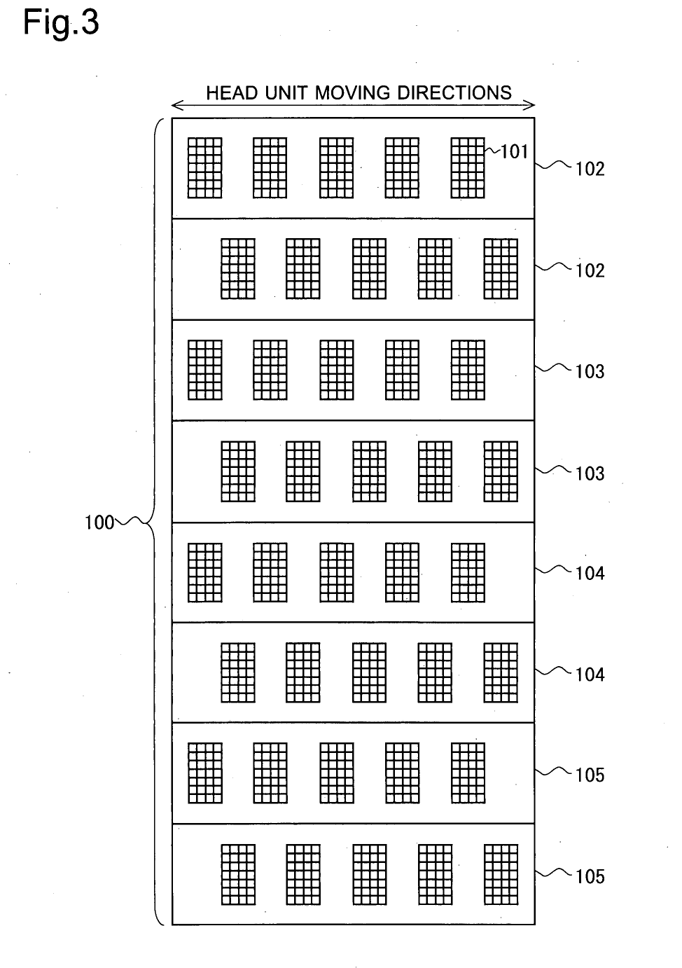

While the following describes a cleaning operation, etc., by taking as an example the C color head unit 102, the head units 103 to 105 for other colors also operate in a similar manner. In addition, the inkjet printer according to the present embodiment is provided with one head unit for each color, but two head units may be provided for each color as shown in FIG. 3 or three or more head units may be provided for each color.

<1.3 Configuration of Cleaning Portion>

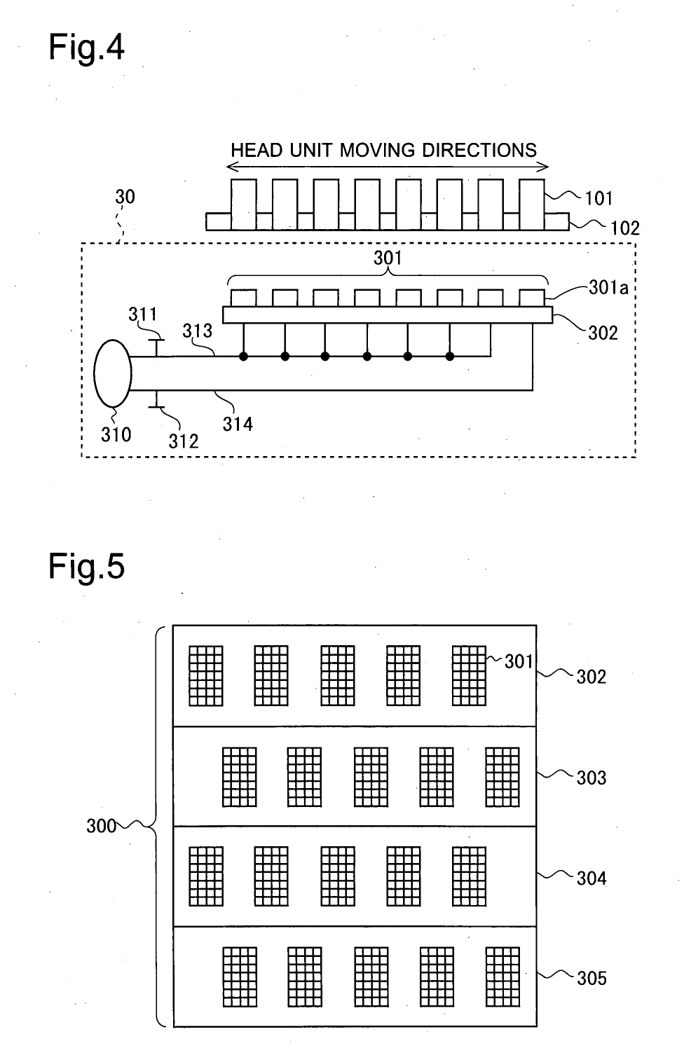

Next, referring to FIG. 4, the configuration of the cleaning portion (cleaning mechanism) 30 will be described. FIG. 4 is a cross-section view of the cleaning portion 30 and the head unit 102. The cleaning portion 30 includes a capping unit 302 as a capping mechanism, which includes a plurality of caps 301, a pump 310, a valve (first valve) 311, a valve (second valve) 312, and tubes (suction tubes) 313 and 314. The caps 301 each cover a printing surface of an inkjet head 101 opposed thereto to seal the printing surface. The capping unit 302 is capable of moving up and down. The pump 310 sucks ink from nozzles of the inkjet heads 101. The valves 311 and 312 control ink suction by the pump 310. Specifically, when the valves are open, ink is sucked by the pump 310 via the valves, and when the valves are closed, no ink is sucked by the pump 310 via the valves. The tubes 313 and 314 are passages through which ink is sucked by the pump 310. Although only the C color capping unit 302 is shown in FIG. 4, one cleaning unit is composed of a combination of C, M, Y and K color capping units.

One of the plurality of caps 301 included in the capping unit 302 that is denoted by reference character 301a in FIG. 4 (hereinafter, referred to as a “separate cleaning cap”) is a cap for separately cleaning any one inkjet head (selected printhead) 101 that is selected from among the inkjet heads 101 included in the head unit 102. Note that in the present embodiment, a separate cleaning portion is implemented by the separate cleaning cap 301a.

FIG. 5 is a plan view of the cleaning unit 300 as viewed from the top in the present embodiment. The cleaning unit 300 is comprised of four capping units 302 to 305, each having a plurality of caps 301. The capping unit 302 includes caps 301 for covering printing surfaces of the inkjet heads 101 provided in the C color head unit 102. The capping unit 303 includes caps 301 for covering printing surfaces of the inkjet heads 101 provided in the M color head unit 103. The capping unit 304 includes caps 301 for covering printing surfaces of the inkjet heads 101 provided in the Y color head unit 104. The capping unit 305 includes caps 301 for covering printing surfaces of the inkjet heads 101 provided in the K color head unit 105. Note that in the case where two head units are provided for each color as shown in FIG. 3, the cleaning unit 300 is also provided with two capping units for each color.

<1.4 Cleaning Operation>

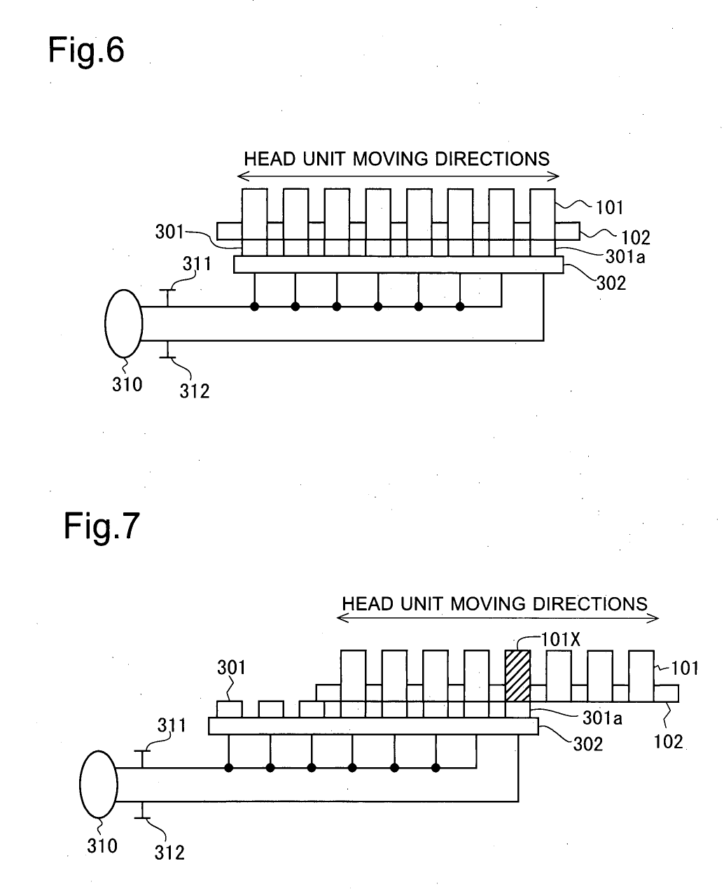

Next, the operation performed in the printer section 2 for subjecting the inkjet heads 101 to a cleaning process in the present embodiment (hereinafter, referred to as the “cleaning operation”) is described with reference to FIGS. 6 and 7. In the present embodiment, a cleaning process (a first cleaning process) is performed on all inkjet heads 101, for example, at the time of power-on (hereinafter, referred to as “at the time of steady state”), and a separate cleaning process (a second cleaning process) is performed on a selected inkjet head 101, for example, at the time of occurrence of defective ink ejection (hereinafter, referred to as “at the time of occurrence of defective ejection”). Each of the cleaning operation at the time of steady state and the cleaning operation at the time of occurrence of defective ejection will be described below. Note that at the time when no printing process is being performed in the printer (hereinafter, referred to as “at the time of standby state”), the printing surfaces of the inkjet heads 101 provided in the head unit 102 are covered and sealed by the caps 301 provided in the capping unit 302 as shown in FIG. 6 to prevent the nozzles of the inkjet heads 101 from being dried out.

First, the cleaning operation at the time of steady state will be described. At the time of steady state, a cleaning process is performed on each inkjet head 101 placed in the state shown in FIG. 6. That is, the cleaning is performed on the printing surfaces of all the inkjet heads 101 provided in the head unit 102 when they are covered with the caps 301. Note that if the state shown in FIG. 6 is not brought about at the start of cleaning, the head carriage controller 220 causes the head unit 102 to move to a predetermined position, and thereafter the capping unit controller 210 causes the capping unit 302 to be elevated. As a result, the state shown in FIG. 6 is brought about.

The ink suction by the pump 310 is performed in the state shown in FIG. 6, the valve controller 215 keeps both of the two valves 311 and 312 open at the time of steady state. As a result, ink is sucked from the separate cleaning cap 301a and also from the caps 301 other than the separate cleaning cap 301a. Thus, at the time of steady state, the cleaning process is performed on all the inkjet heads 101 provided in the head unit 102.

Next, the cleaning operation at the time of occurrence of defective ejection will be described. Note that the following description is based on the assumption that defective ink ejection has occurred in the inkjet head denoted by reference character 101X in FIG. 7 (hereinafter, referred to as the “defective ejection head”). When defective ink ejection occurs, the head carriage controller 220 causes the head unit 102 to move to a predetermined position, such that the printing surface of the defective ejection head 101X is covered with the separate cleaning cap 301a by elevating the capping unit 302. Thereafter, the capping unit controller 210 causes the capping unit 302 to be elevated. As a result, the printing surface of the defective ejection head 10X is covered with the separate cleaning cap 301a as shown in FIG. 7.

The suction of ink by the pump 310 is performed in the state shown in FIG. 7, the valve controller 215 keeps the valve 312 open at the time of occurrence of defective ejection, while keeping the valve 311 closed. Accordingly, ink is sucked from the separate cleaning cap 301a, but not from the caps 301 other than the separate cleaning cap 301a. As a result, among the inkjet heads 101 provided in the head unit 102, only the defective ejection head 101X is subjected to a cleaning process at the time of occurrence of defective discharge.

<1.5 Effect>

In the present embodiment, as described above, ink is sucked only from the defective ejection head 101X at the time of occurrence of defective ejection. Accordingly, it is also possible to perform a cleaning process in such a manner as to separately suck ink from an inkjet head 101, other than just sucking ink from all the inkjet heads 101. Therefore, it is possible to suck ink only from any inkjet head 101 that requires ink suction without sucking ink from inkjet heads 101 that do not require ink suction, for example, because any defective ejection has not occurred therein. As a result, it is possible to suppress unnecessary suction of ink, and reduce ink consumption. In addition, making difference in ink flow between the inkjet heads 101 can be eliminated, whereby it is possible to suppress unnecessary suction of ink at the time of filling ink. Furthermore, in the present embodiment, the same capping unit 302 is used for performing both the cleaning process for all the inkjet heads 101 and the cleaning process for any specific inkjet head 101. That is, switching between the processes is achieved without providing a plurality of cleaning mechanisms. Thus, the inkjet printer according to the present embodiment can be achieved at low cost without enlarging the apparatus size.

<1.6 Variant>

<1.6.1 First Variant>

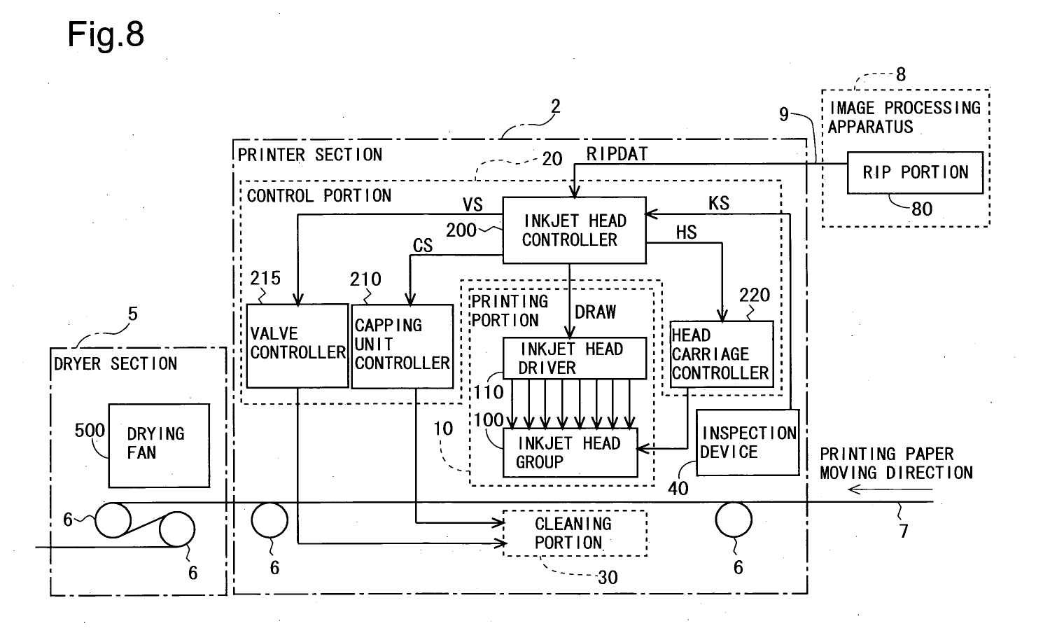

FIG. 8 is a schematic configuration diagram of a substantial portion of an inkjet printer according to a first variant of the first embodiment. This printer is provided with an inspection device 40 for inspecting whether any defective ejection has occurred. Since the rest of the configuration is the same as in the first embodiment shown in FIG. 1, the same elements are denoted by the same reference characters, and the description thereof will be omitted.

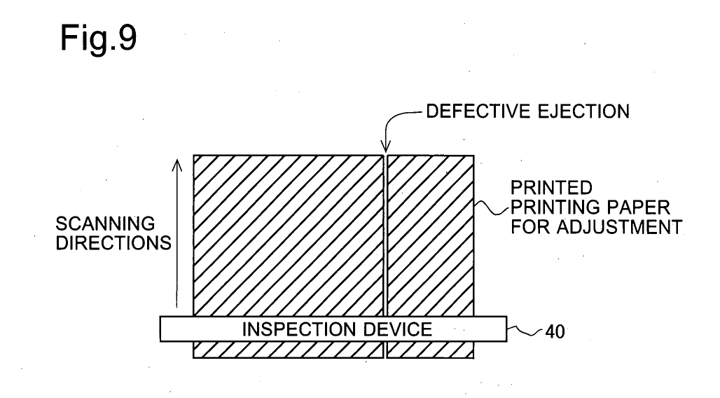

FIG. 9 is a diagram for explaining the operation of the inspection device 40. In the present variant, in order to inspect whether any defective ink ejection has occurred, a predetermined adjustment print image is initially printed on a sheet of printing paper. Thereafter, the sheet of printing paper having the adjustment print image printed thereon is scanned by the inspection device 40 as shown in FIG. 9. As a result, information concerning the image printed on the sheet of printing paper is read by the inspection device 40. The inspection device 40 detects a missing portion of the print based on the information of the image, and identifies an inkjet head (a defective ejection head) having a defect in ejecting ink. Then, the inspection device 40 provides the inkjet head controller 200 with an inspection result signal KS for identifying the defective ejection head. The inkjet head controller 200 controls the inkjet head driver 110, the capping unit controller 210, the valve controller 215 and the head carriage controller 220 in accordance with the inspection result signal KS. As a result, the defective ejection head is identified without requiring any manual effort, and a separate cleaning process is performed on the defective ejection head.

Thus, according to the present variant, it is possible to identify a defective ejection head, and perform a separate cleaning process on the defective ejection head without requiring any manual effort. For example, if the inspection device 40 is configured to perform inspection at the time of replacing printing paper (e.g., a roll sheet), the inkjet heads 101 are regularly maintained, reducing the occurrence of defective print on printed media outputted by the user.

<1.6.2 Second Variant>

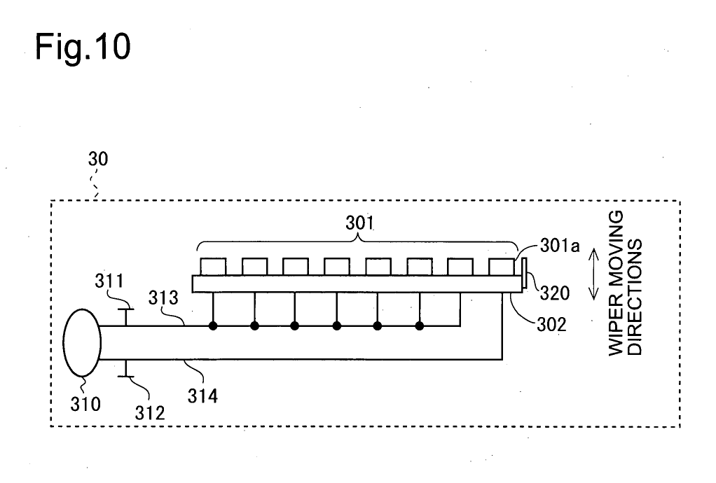

FIG. 10 is a cross-section view of a cleaning portion 30 according to a second variant of the first embodiment. In the present variant, a wiper 320 is provided at an end of the capping unit 302 of the cleaning portion 30. The wiper 320 is provided for wiping (wiping off dirt from) the printing surfaces of the inkjet heads 101. The wiper 320 is capable of moving in the directions indicated by the arrow in FIG. 10.

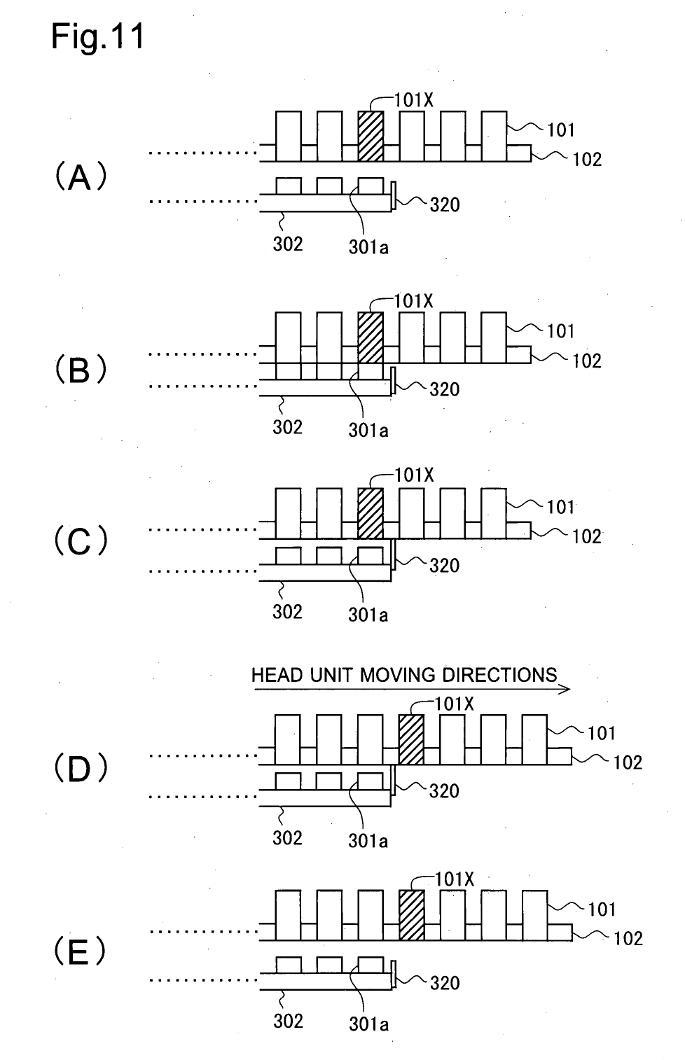

FIG. 11 is a diagram for explaining a cleaning operation in the present variant. When performing a separate cleaning process (a second cleaning process) on a defective ejection head 101X, first, the head carriage controller 220 causes the head unit 102 to move in such a manner that a defective ejection head 101× and a separate cleaning cap 301a are opposed to each other as shown in FIG. 11A. Then, the capping unit controller 210 causes the capping unit 302 to be elevated. As a result, the printing surface of the defective ejection head 101X is covered with the separate cleaning cap 301a as shown in FIG. 11B. In this state, ink suction by the pump 310 is performed. At this time, among the inkjet heads 101 provided in the head unit 102, only the defective ejection head 101X is subjected to the ink suction as described above.

After the ink suction by the pump 310, the capping unit controller 210 causes the capping unit 302 to be lowered, while causing the wiper 320 to be elevated as shown in FIG. 11C. After the elevation of the wiper 320, the head carriage controller 220 causes the head unit 102 to move in the direction indicated by the arrow in FIG. 11D. As a result, the printing surface of the defective ejection head 101X is wiped by the wiper 320. Thereafter, the capping unit controller 210 causes the wiper 320 to be lowered. As a result, the state shown in FIG. 11E is brought about.

Thus, according to the present variant, when cleaning the inkjet heads 101, it is possible to wipe only the defective ejection head 101X, and therefore the cleaning process for the inkjet heads 101 is performed more effectively.

### 2. Second Embodiment

<2.1 Overall Configuration, etc.>

Next, a second embodiment of the present invention will be described. The schematic configuration of a substantial portion of an inkjet printer according to the second embodiment of the present invention, the configuration of the inkjet head group 100 and the configuration of the cleaning portion 30 are the same as in the first embodiment, and therefore the description thereof will be omitted. Note that the schematic configuration of the substantial portion is as shown in FIG. 1, the configuration of the inkjet head group 100 is as shown in FIG. 2, and the configuration of the cleaning portion 30 is as shown in FIGS. 4 and 5.

In the first embodiment, when defective ink ejection occurs, a separate cleaning process is performed on an inkjet head 101 having a ejection defect. In the present embodiment, on the other hand, in view of the fact that inkjet heads 101 that are not involved in a printing process are susceptible to defective ejection, the control portion 20 detects any inkjet head 101 that is not involved in a printing process or that is involved in a printing process for a time period that constitutes a relatively small portion of a predetermined time period, and the detected inkjet head 101 is subjected to a separate cleaning process. Hereinbelow, first and second examples will be described.

### 2.2 First Example

<2.2.1 Configuration, Operation, etc., of Printer Section>

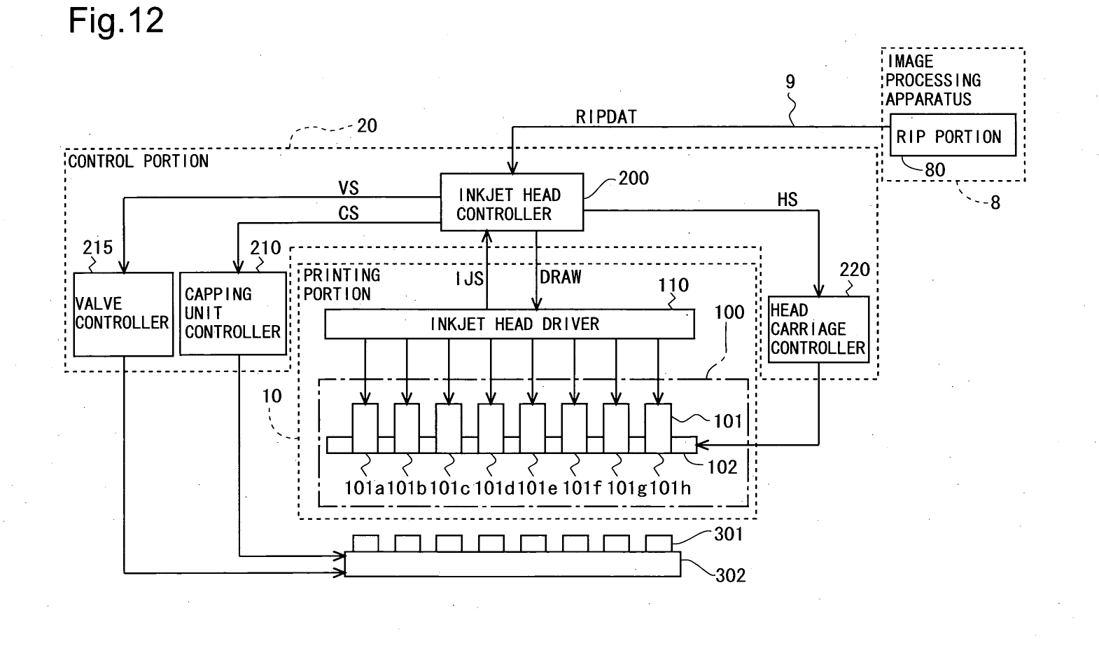

FIG. 12 is a block diagram for explaining the operation of the printer section 2 in the present example. Note that the printer includes inkjet heads denoted by reference characters 101a to 101h as shown in FIG. 12.

The inkjet head controller 200 provides a drawing signal DRAW to the inkjet head driver 110 based on image data RIPDAT sent from the RIP portion 80 in the image processing apparatus 8, and also provides a capping unit movement instruction signal CS for controlling the elevating and lowering of the capping unit 302 to the capping unit controller 210, a valve control signal VS for controlling the opening and closing of the valves 311 and 312 to the valve controller 215, and a head unit movement instruction signal HS for controlling the movement of the head unit 102 to the head carriage controller 220. The inkjet head driver 110 drives the inkjet heads 101a to 101h in accordance with the drawing signal DRAW. At this time, the inkjet head driver 110 provides an inkjet head operating condition signal IJS, which indicates the operating condition of each of the inkjet heads 101a to 101h, to the inkjet head controller 200. The inkjet head operating condition signal IJS may represent, for example, activeness/inactiveness of each of the inkjet heads 101a to 101h in predetermined units of image data or activeness/inactiveness of each of the inkjet heads 101a to 101h in predetermined units of time.

The inkjet head controller 200 detects any inkjet head that is not involved in a printing process (hereinafter, referred to as an “inactive inkjet head”) in accordance with the inkjet head operating condition signal IJS. In general, the inactive inkjet head is more susceptible to defective ejection than an active inkjet head. Accordingly, in the present embodiment, when any inactive inkjet head is detected, the inactive inkjet head is subjected to a separate cleaning process. Note that in the present embodiment, an operating condition monitoring section is implemented by the inkjet head controller 200 and the inkjet head driver 110.

<2.2.2 Cleaning Operation>

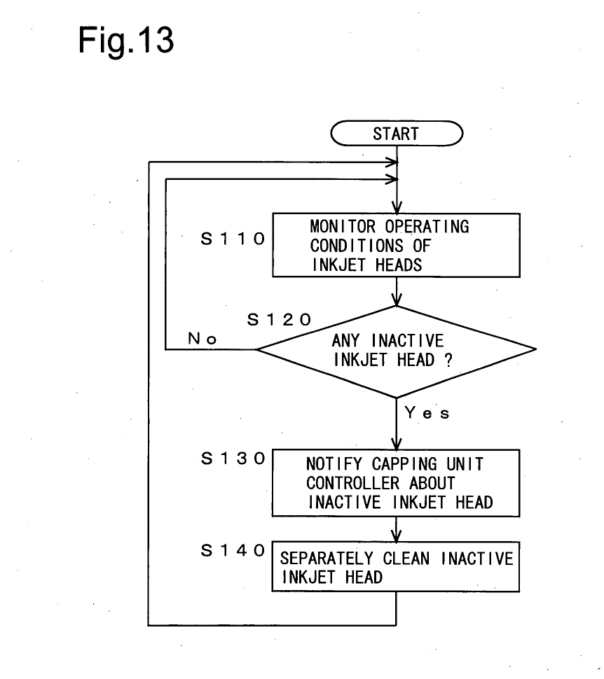

FIG. 13 is a flowchart for explaining the operation performed in the printer section 2 for subjecting an inkjet head 101 to a separate cleaning process in the present embodiment. In the present embodiment, it is assumed that the separation cleaning process is performed upon each printing of a Whole piece of image data. When a printing process is started in the printer, the inkjet head controller 200 receives an inkjet head operating condition signal IJS from the inkjet head driver 110 in order to monitor the operating condition of each of the inkjet heads 101a to 101h (step S110). After completion of the printing process for the whole piece of image data, the inkjet head controller 200 determines whether there is any inactive inkjet head based on the inkjet head operating condition signal IJS (step S120). If the determination result is that there is an inactive inkjet head, the procedure proceeds to step S130, and if there is no inactive inkjet head, the procedure returns to step S110. In step S130, the inkjet head controller 200 provides the capping unit controller 210 with a capping unit movement instruction signal CS as an information for identifying the inactive inkjet head based on the inkjet head operating condition signal IJS. For example, when the inkjet head denoted by reference character 101b in FIG. 12 is inactive, an information indicating that the inkjet head 101b is inactive is provided to the capping unit controller 210 by the capping unit movement instruction signal CS. Upon completion of step S130, the procedure proceeds to step S140 where the capping unit controller 210 causes the capping unit 302 to perform a desired operation, such that the inactive inkjet head is subjected to a cleaning process, in accordance with the capping unit movement instruction signal CS. In this manner, the separate cleaning process is performed on the inactive inkjet head. Note that the operation from step S110 to step S140 is repeated until the completion of the printing process.

<2.2.3 Effect>

In the present embodiment, as described above, any inkjet head 101 that is to be subjected to a separate cleaning process is identified based on the operating condition of each of the inkjet heads 101a to 101h included in the inkjet head group 100. Therefore, a separate cleaning process is performed in advance on any inkjet head 101 that is highly likely to have an ejection defect, whereby the occurrence of the defective ejection can be prevented in advance. In addition, the inkjet head 101 that is to be subjected to the cleaning process is detected by the inkjet head controller 200, and therefore the inkjet head 101 that is to be subjected to the separate cleaning process is automatically identified without requiring any manual effort. Furthermore, as in the first embodiment, ink suction is not performed on any inkjet head 101 that requires no ink suction, but ink suction is performed on only the inkjet head 101 that requires ink suction, and therefore unnecessary ink suction is suppressed, resulting in a reduction of ink consumption.

### 2.3 Second Example

<2.3.1 Configuration and Operation of Printer Section and Detection of Inactive Inkjet Head>

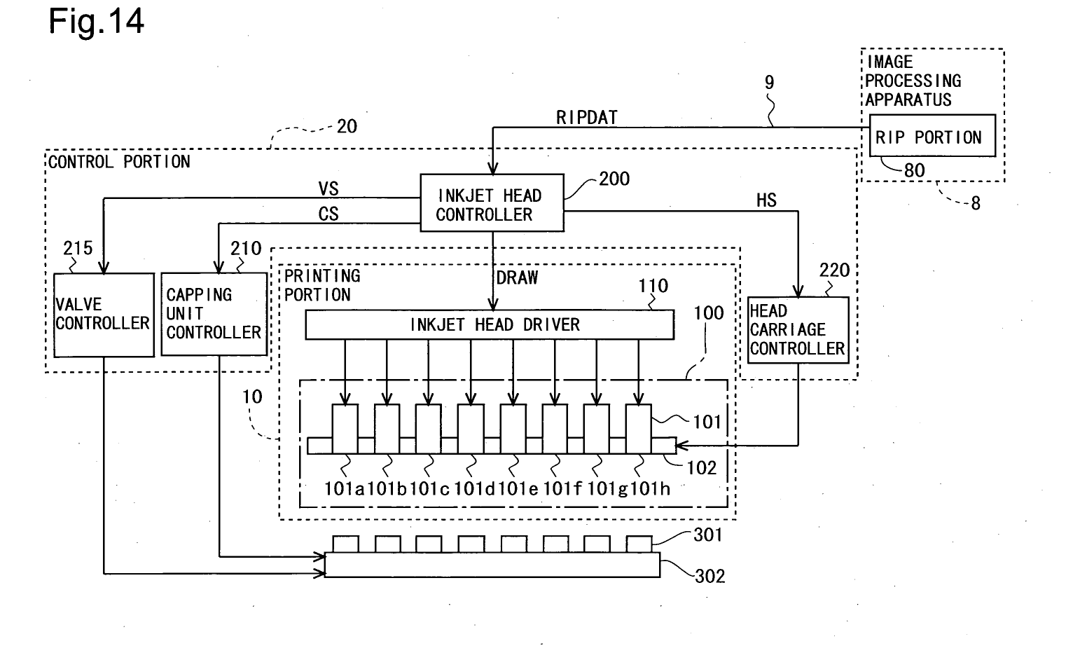

Next, a second example will be described. FIG. 14 is a block diagram for explaining the operation of the printer section 2 in the present example. The inkjet head controller 200 provides a drawing signal DRAW to the inkjet head driver 110 based on an image data RIPDAT sent from the RIP portion 80 in the image processing apparatus 8, and also provides a capping unit movement instruction signal CS for controlling the elevating and lowering of the capping unit 302 to the capping unit controller 210, a valve control signal VS for controlling the opening and closing of the valves 311 and 312 to the valve controller 215, and a head unit movement instruction signal HS for controlling the movement of the head unit 102 to the head carriage controller 220. The inkjet head driver 110 drives the inkjet heads 101a to 101h in accordance with the drawing signal DRAW.

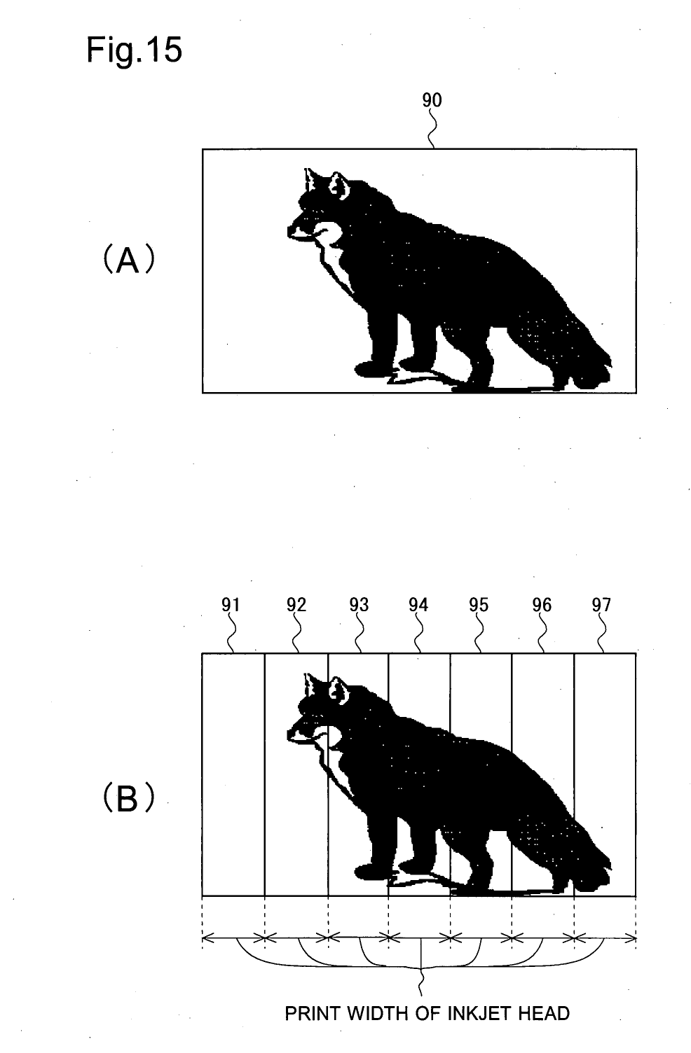

In the first example, an inkjet head 101 that is targeted for a separate cleaning process is identified based on the operating condition of each of the inkjet heads 110a to 101h. In the present example, on the other hand, an inactive inkjet head 101 is detected based on the image data RIPDAT sent from the RIP portion 80 in the image processing apparatus 8, and the detected inkjet head 101 is identified as a target for the separation cleaning process. This is described with reference to FIG. 15.

In the present example, the inkjet head controller 200 divides the image data RIPDAT sent from the RIP portion 80 in the image processing apparatus 8 into a plurality of pieces of image data, each corresponding to a print width of an inkjet head 101. For example, when image data 90 as shown in FIG. 15A is sent from the image processing apparatus 8, the inkjet head controller 200 divides the image data 90 into a plurality of pieces of image data 91 to 97, each corresponding to a print width of an inkjet head 101, as shown in FIG. 15B. Looking at, for example, the image data 91 resulted from the division, there is no image to be printed. Accordingly, while the image data 90 is being printed, inkjet heads 101 which should print the divided image data 91 do not operate at all. As described above, the inactive inkjet heads 101 are susceptible to defective ejection. Therefore, the inkjet heads 101 associated with printing of the image data 91 resulted from the division may be targeted for a separate cleaning process. In the present example, any inkjet head 101 targeted for a separate cleaning process is identified based on contents of the divided image data. Note that in the present example, an operating condition sensing section is implemented by the inkjet head controller 200.

<2.3.2 Cleaning Operation>

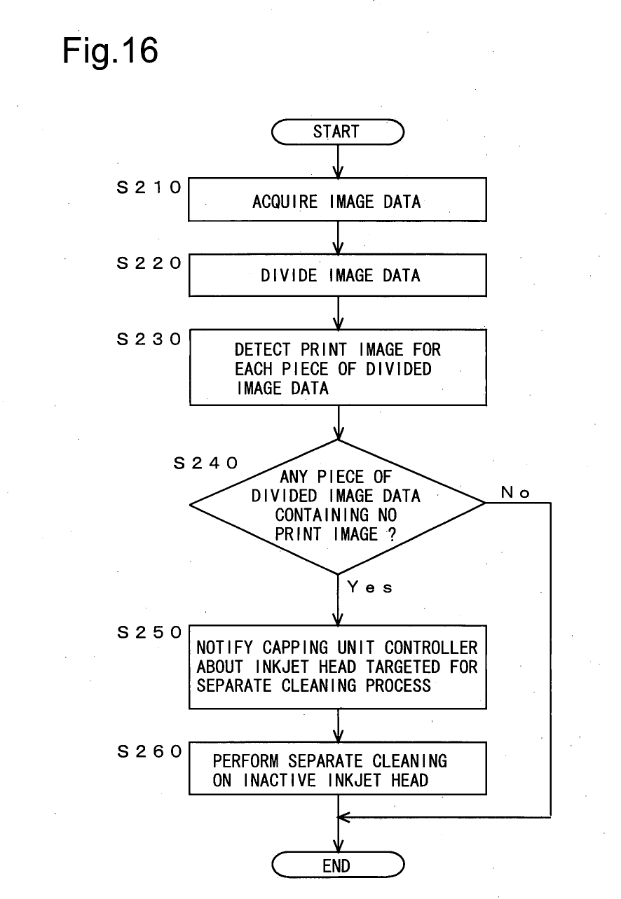

FIG. 16 is a flowchart for explaining the operation performed in the printer section 2 for subjecting an inkjet head 101 to a separate cleaning process in the present example. When image data RIPDAT is sent from the image processing apparatus 8, the inkjet head controller 200 receives the image data RIPDAT (step S210). Thereafter, the inkjet head controller 200 divides the image data RIPDAT into a plurality of pieces of image data, each corresponding to a print width of an inkjet head 101 (step S220). Furthermore, for each piece of the divided image data, the inkjet head controller 200 performs a detection of an image that is to be printed (hereinafter referred to as a “print image”) (step S230). Thereafter, the inkjet head controller 200 determines whether there is any piece of the divided image data that contains no print image (step S240). If the determination result is that there is a piece of the divided image data that contains no print image, the procedure proceeds to step S250. On the other hand, if there is no piece of the divided image data that contains no print image, the procedure ends. Note that, determining whether any print image is present for each color in step S240, it is possible to identify any inkjet head 101 corresponding to a color that is not involved in the printing process.

In step S250, the inkjet head controller 200 provides a capping unit movement instruction signal CS as an information for identifying the inkjet head 101 that is to be subjected to the separate cleaning process to the capping unit controller 210 based on the piece of the divided image data that contains no print image. After completion of step S250, the procedure proceeds to step S260 where the capping unit controller 210 causes the capping unit 302 to perform a desired operation, such that the inkjet head 101 targeted for the separate cleaning process is cleaned, in accordance with the capping unit movement instruction signal CS. In this manner, an inactive inkjet head 101 is identified based on the image data RIPDAT, and the separate cleaning process is performed on the inkjet head 101.

<2.3.3 Effect>

According to the present example, unlike the configuration in the first example, inkjet head operating condition signal IJS which is transmitted from the inkjet head driver 110 to the inkjet head controller 200 becomes unnecessary. Also, in the present example, before the inkjet heads 101 actually operate, any inkjet head 101 that is to be in an inactive state at the time of printing is identified. Accordingly, it is possible to, before printing, perform a separate cleaning process on any inkjet head 101 that is to be placed in an inactive state, and it is also possible to perform the separate cleaning before and after printing. Thus, the occurrence of the defective ejection can be prevented more effectively.

<2.3.4 Others>

An inkjet head 101 that is to be targeted for a separate cleaning process is identified based on whether there is any divided image data that contains no print image in the second example, but the inkjet head 101 that is to be targeted for a separate cleaning process may be identified based on the percentage of presence of a print image in the divided image data (a print ratio). This is described below.

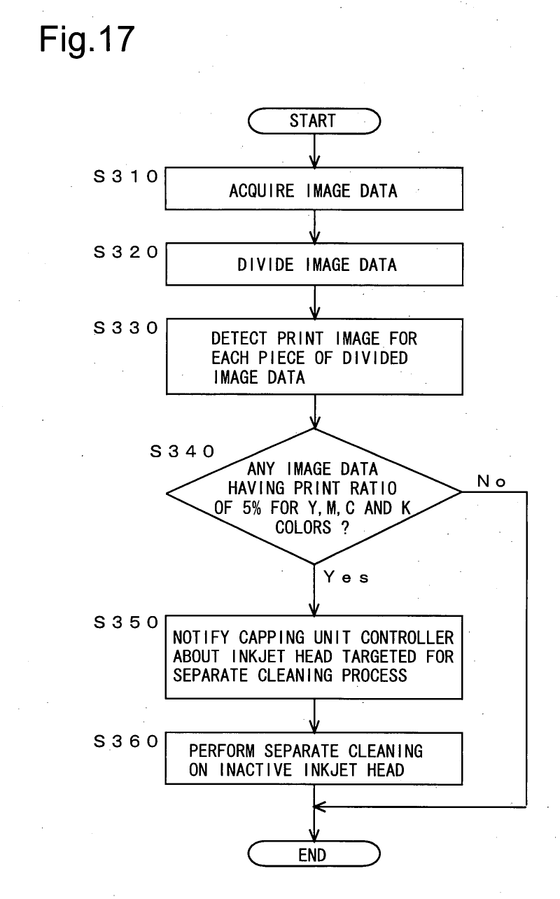

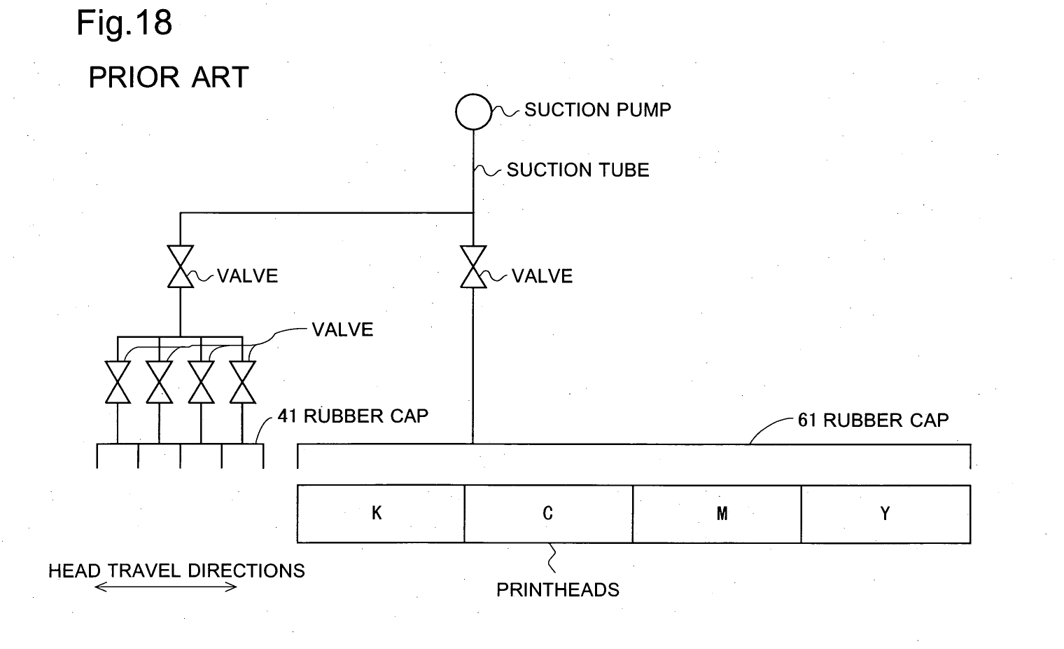

Looking at the divided image data 97 in FIG. 15B, a print image is present only in a portion near the bottom end. Accordingly, as for an inkjet head 101 which should print the divided image data 97, a time period in which it is placed in an inactive state is relatively long. In addition, as for other pieces of the divided image data, some color might be barely used. Therefore, any inkjet head 101 that remains in an inactive state for a time period equal to or more than a predetermined percentage of a given time period is detected based on the percentage of presence of print image in the divided image data (the print ratio) for each color, so that such inkjet heads 101 can be targeted for a separate cleaning process. FIG. 17 shows a flowchart illustrating the operation performed in the printer section 2 for achieving this. Note that in FIG. 17, steps other than step S340 are the same as those in the second example (see FIG. 16), and therefore the description thereof will be omitted.

In step S340 of FIG. 17, the inkjet head controller 200 determines whether there is any piece of the divided image data which has a print ratio of 5% or less. Note that the determination is performed on a color-by-color basis. If the determination result is that there is any piece of the divided image data which has a print ratio of 5% or less, the procedure proceeds to step S350. On the other hand, if there is not a piece of the divided image data which has a print ratio of 5% or less, the procedure ends.

With the above configuration, based on the print ratio of each inkjet head 101, it is determined whether or not it is targeted for a separate cleaning process. For example, looking at the divided image data 95 resulted in FIG. 15B, it is assumed that a print ratio for each of the Y and K colors exceeds 5%, but a print ratio for each of the M and C colors is 5% or less. In such a case, in step S340, of all inkjet heads 101 that are used for printing the divided image data 95, inkjet heads 101 for M and C colors are identified as targets for the separate cleaning process. Then, in step S360, the separate cleaning process is performed on each of the inkjet heads 101 for M and C colors. In this manner, any inkjet head 101 that is to be targeted for a separate cleaning process is identified based on the print ratio of image data, and therefore it is possible to effectively perform a cleaning process on any inkjet head 101 relatively susceptible to defective ejection. Note that the print ratio used as a threshold for the determination in step S340 is not limited to 5%, and may be determined depending on, for example, requirements of individual printer and so on.

1. A printing apparatus having a plurality of printheads, each performing printing by ejecting ink from a printing surface thereof to deposit the ink on printing paper, the apparatus comprising:
a cleaning mechanism for cleaning the plurality of printheads, the mechanism performing a first cleaning process for collectively cleaning a predetermined number of printheads from among the plurality of printheads and a second cleaning process for separately cleaning only one selected printhead, which is selected from among the predetermined number of printheads; and
a control portion for controlling an operation of the cleaning mechanism,
wherein the control portion switches between the first cleaning process and the second cleaning process in the cleaning mechanism.

2. The printing apparatus according to claim 1,
wherein the cleaning mechanism includes a separate cleaning portion for separately cleaning the selected printhead in the second cleaning process, and
wherein the control portion causes the separate cleaning portion to clean a predetermined printhead from among the predetermined number of printheads in the first cleaning process.

3. The printing apparatus according to claim 2,
wherein the cleaning mechanism:
includes a plurality of capping mechanisms for sealing each printing surface of the predetermined number of printheads;
cleans the printheads by sucking the ink therefrom via the capping mechanisms,
wherein the control portion:
causes the cleaning mechanism to suck the ink from the predetermined number of printheads via the plurality of capping mechanisms in the first cleaning process;
causes the cleaning mechanism to suck the ink from the selected printhead via the capping mechanism as the separate cleaning portion in the second cleaning process.

4. The printing apparatus according to claim 3,
wherein the cleaning mechanism includes a first valve which, in an open state, allows the ink to be sucked via the capping mechanisms, excluding the capping mechanism as the separate cleaning portion of the plurality of capping mechanisms, and a second valve which, in an open state, allows the ink to be sucked via the capping mechanism as the separate cleaning portion,
wherein the control portion includes a valve controller for controlling an opening and closing operation of the first valve and an opening and closing operation of the second valve,
wherein the valve controller:
keeps the first valve and the second valve open in the first cleaning process;
keeps the first valve closed, while keeping the second valve open, in the second cleaning process.

5. The printing apparatus according to claim 1, further comprising an inspection device for detecting a printhead having a defect in ejecting the ink from among the plurality of printheads.

6. The printing apparatus according to claim 1,
wherein the cleaning mechanism further includes a wiper for wiping the printing surfaces of the predetermined number of printheads, and
wherein the control portion causes the wiper to wipe the printing surface of the selected printhead in the second cleaning process.

7. The printing apparatus according to claim 1, further comprising an operating condition monitoring section for monitoring operating conditions of the plurality of printheads,
wherein when an inactive printhead is detected by the operating condition monitoring section, the control portion causes the cleaning mechanism to operate in such a manner that the second cleaning process is performed on the inactive printhead.

8. A printing apparatus having a plurality of printheads, each performing printing by ejecting ink from a printing surface thereof to deposit the ink on printing paper, the apparatus comprising:
a cleaning mechanism for cleaning the plurality of printheads, the mechanism performing a first cleaning process for collectively cleaning a predetermined number of printheads from among the plurality of printheads and a second cleaning process for separately cleaning only one selected printhead, which is selected from among the predetermined number of printheads;
a control portion for controlling an operation of the cleaning mechanism, the operation including switching between the first cleaning process and the second cleaning process; and
an operating condition sensing section for sensing operating conditions of the plurality of printheads based on externally provided image data,
wherein the operating condition sensing section detects, as a separate cleaning target printhead, a printhead that is inactive for a time period equal to or more than a predetermined percentage of a given time period, and
wherein when one or more separate cleaning target printheads are detected by the operating condition sensing section, the control portion causes the cleaning mechanism to operate in such a manner that the second cleaning process is performed on each of the one or more separate cleaning target printheads as the selected printhead.

9. The printing apparatus according to claim 8, wherein the operating condition sensing section divides the image data into a plurality of pieces of image data, each corresponding to a print width of a printhead, and obtains a print ratio of each printhead in a predetermined period based on the divided image data, and detects the separate cleaning target printhead based on the print ratio.

10. The printing apparatus according to claim 9, wherein the operating condition sensing section detects a printhead having a print ratio of 0% as the separate cleaning target printhead.

11. The printing apparatus according to claim 9, wherein the operating condition sensing section detects a printhead having a print ratio equal to or less than a predetermined print ratio as the separate cleaning target printhead.

12. The printing apparatus according to claim 8,
wherein the cleaning mechanism includes a separate cleaning portion for separately cleaning the selected printhead in the second cleaning process, and
wherein the control portion causes the separate cleaning portion to clean a predetermined printhead from among the predetermined number of printheads in the first cleaning process.

13. The printing apparatus according to claim 12,
wherein the cleaning mechanism:
includes a plurality of capping mechanisms for sealing each printing surface of the predetermined number of printheads;
cleans the printheads by sucking the ink therefrom via the capping mechanisms,
wherein the control portion:
causes the cleaning mechanism to suck the ink from the predetermined number of printheads via the plurality of capping mechanisms in the first cleaning process;
causes the cleaning mechanism to suck the ink from the selected printhead via the capping mechanism as the separate cleaning portion in the second cleaning process.

14. The printing apparatus according to claim 13,
wherein the cleaning mechanism includes a first valve which, in an open state, allows the ink to be sucked via the capping mechanisms, excluding the capping mechanism as the separate cleaning portion of the plurality of capping mechanisms, and a second valve which, in an open state, allows the ink to be sucked via the capping mechanism as the separate cleaning portion,
wherein the control portion includes a valve controller for controlling an opening and closing operation of the first valve and an opening and closing operation of the second valve,
wherein the valve controller:
keeps the first valve and the second valve open in the first cleaning process;
keeps the first valve closed, while keeping the second valve open, in the second cleaning process.

15. The printing apparatus according to claim 8, further comprising an inspection device for detecting a printhead having a defect in ejecting the ink from among the plurality of printheads.

16. The printing apparatus according to claim 8,
wherein the cleaning mechanism further includes a wiper for wiping the printing surfaces of the predetermined number of printheads, and
wherein the control portion causes the wiper to wipe the printing surface of the selected printhead in the second cleaning process.

17. A cleaning mechanism for a printing apparatus having a plurality of printheads, wherein a first cleaning process for collectively cleaning a predetermined number of printheads from among the plurality of printheads and a second cleaning process for separately cleaning only one selected printhead selected from among the predetermined number of printheads can be switched.

18. The cleaning mechanism according to claim 17, comprising a separate cleaning portion for separately cleaning the selected printhead in the second cleaning process,
wherein the separate cleaning portion cleans a predetermined printhead from among the predetermined number of printheads in the first cleaning process.
